(19) United States
(12) Patent Application Publication
(10) Pub. No.: US 2009/0087531 A1
(43) Pub. Date: Apr. 2, 2009

(54) GRAIN HYDRATION AND FLAKING PROCESS, APPARATUS, AND PRODUCT

(75) Inventors: GARY ANDERS, Gainesville, GA (US); Larry Doskocil, Hutchinson, KS (US); Justin Sindt, Lyons, KS (US); William H. Frazier, Hutchinson, KS (US)

Correspondence Address: FELLERS SNIDER BLANKENSHIP;BAILEY & TIPPENS, THE KENNEDY BUILDING, 321 SOUTH BOSTON SUITE 800, TULSA, OK, 74103-3318, US

(73) Assignee: PRODUCTION SYSTEMS, L.L.C., SOUTH HUTCHINSON, KS (US)

(21) Appl. No.: 12/107,195

(22) Filed: Apr. 22, 2008

Related U.S. Application Data
(63) Continuation-in-part of application No. 11/962,610, filed on Dec. 21, 2007, now abandoned.
(60) Provisional application No. 60/871,395, filed on Dec. 21, 2006.

(51) Int. Cl. A23K 1/00; A23L 1/10

(52) U.S. Cl. 426/457; 366/144; 426/461

(57) ABSTRACT

An apparatus and related method for preparing grain for animal ingestion. The apparatus comprises an elongate cooking vessel having a rounded interior bottom portion and a rotating mixing and impacting assembly which extends longitudinally in the vessel from the inlet end to the outlet end thereof. The mixing and impacting assembly comprises: a center shaft; a plurality of mixing blades which rotate with and extend substantially parallel to the center shaft; and a plurality of elongate paddles which also rotate with and extend substantially parallel to the center shaft. The mixing blades travel beneath the grain surface level for stirring the grain material. The paddles are closer to the center shaft than are the mixing blades such that the paddles impact and displace the grain surface level.

### RELATED APPLICATION

This application is a continuation-in-part of U.S. patent application Ser. No. 11/962,610, filed Dec. 21, 2007 which claims the benefit of U.S. Provisional Patent Application Ser. No. 60/871,395, filed on Dec. 21, 2006, the disclosures of which are incorporated herein by reference as if fully set out at this point.

### FIELD OF THE INVENTION

A cooking and hydration method and apparatus used to process corn and other grains prior, for example, to a flaking operation in a feedlot application.

### BACKGROUND OF THE INVENTION

Corn is fed to animals as either a whole grain supplement or as some portion of it. It can be fed as Whole Kernel, Cracked, or Flaked. Feeding whole kernel corn to animals limits its nutritional value since the stomach of the animal has a difficult time digesting through the tough external shell (hull) of the kernel. Because of this, a great deal of the internal starch of the corn will not be exposed to the digestion system and travels through the animal with low nutritional value.

The next alternative is to crack open the kernel in either a hammer mill or “dry” roller. This will cause the whole kernel to be broken into many pieces, thus exposing the starch, which is a great improvement over feeding whole kernel corn and greatly enhances the nutritional value of the corn. However, this creates very small pieces of corn either as dust or fines, which can increase product lost in the distribution process or is less desirable to the animal.

The last alternative, which is the best method, is to cook the corn, converting the raw starch to cooked or gelatinized starch, and to expose that cooked starch outside the hull. To accomplish this, the existing industry methods utilize the following practice: The whole kernel corn is sprayed with water mixed with a surfactant additive thus pre-wetting or coating it and then placed in a holding bin/tank for 1 to 2 hours to allow the liquid to soak into the kernel. It is then transferred into a vertical steam tower where it is exposed to steam for approximately 50 to 60 minutes providing cooking and additional water pick up into the kernel. The cooked corn then drops into grooved rollers where it is pressed into flakes, thus mashing it flat and exposing the starch. Fines and dust are minimized because the corn kernel is soft and pliable and molds easily into the final corn flake shape. The moisture of the flake is typically 18 to 22% and the starch in the kernel is gelatinized to 45 to 60% by a combination of both the cooked state of the corn and the pressure of the rollers. This method is continuous, but requires 2 to 3 hours time and storage tanks.

The conventional method of pre-treating corn in the industry is as described above, to spray water and surfactant onto the surface, let that seep into the corn over a holding time, and then to allow the corn to flow down a steam tower (chest). This is a good system, but takes a great amount of time (2 to 3 hours). A 10,000 head feedlot will run approximately 32,000 lbs of corn per hour through the flaking system. If the process time is 3 hours, this means 96,000 lbs of corn has to be handled in tanks and in a steam tower as in-process inventory, requiring real time management and superstructure to support the volume.

### SUMMARY OF THE INVENTION

The present invention satisfies the needs and alleviates the problems discussed above. In one aspect, there is provided an apparatus for preparing grain for animal ingestion comprising: (a) an elongate cooking vessel including a rounded interior bottom portion, a grain feed inlet end, and a grain product outlet end; (b) a plurality of steam injection nozzles for injecting steam into the cooking vessel; and (c) a plurality of elongate mixing blades extending longitudinally in the cooking vessel. The mixing blades are mounted for rotation in the cooking vessel such that the mixing blades will travel beneath a grain surface level in the cooking vessel when rotated through the rounded interior bottom portion.

In another aspect, there is provided an apparatus for preparing grain for animal ingestion comprising: (a) an elongate cooking vessel including a rounded interior bottom portion, a grain feed inlet end, and a grain product outlet end; (b) a plurality of steam injection nozzles for injecting steam into the cooking vessel; and (c) a plurality of elongate paddles extending longitudinally in the cooking vessel. The paddles are mounted for rotation in the cooking vessel such that the paddles will impact and displace a grain surface level in the cooking vessel when rotating toward the rounded interior bottom portion.

In another aspect, there is provided an apparatus for preparing grain for animal ingestion comprising: (a) an elongate horizontal cooking vessel including a rounded interior bottom portion, a grain feed inlet end, and a cooked grain outlet end and (b) a rotatable mixing and impacting assembly extending longitudinally in the horizontal cooking vessel. The rotatable mixing and impacting assembly comprises: (i) a rotatable elongate center shaft extending substantially from the grain feed inlet end to the cooked grain outlet end; (ii) a plurality of elongate mixing blades which rotate with and extend substantially parallel to the center shaft, the mixing blades being spaced a sufficient distance from the center shaft such that the mixing blades will travel beneath a grain surface level in the horizontal cooking vessel when rotated through the rounded interior bottom portion; and (iii) a plurality of elongate paddles which rotate with and extend substantially parallel to the center shaft, the paddles being positioned closer to the center shaft than are the mixing blades such that the paddles will impact and displace the grain surface level when rotating toward the rounded interior bottom portion.

In another aspect, there is provided a method of preparing grain for animal ingestion comprising the steps of delivering the grain through and cooking the grain in an elongate cooking vessel having a mixing and impacting assembly rotating therein. The mixing and impacting assembly extends longitudinally in the cooking vessel and comprises: (a) an elongate center shaft which is rotating in the cooking vessel; (b) a plurality of elongate mixing blades which are rotating with and which extend substantially parallel to the center shaft, the mixing blades being spaced a sufficient distance from the center shaft such that the mixing blades stir the grain by traveling beneath a grain surface level in the cooking vessel when rotating through a rounded interior bottom portion of the cooking vessel; and (c) a plurality of paddles which are rotating with and which extend substantially parallel to the center shaft, the paddles being positioned closer to the center shaft than are the mixing blades such that the paddles impact and displace the grain surface level as the paddles rotate toward the rounded interior bottom portion. The grain can be delivered through the cooking vessel in non-slurry or in slurry form. If the grain is not suspended in a liquid medium, a sufficient amount of water is preferably applied thereto to achieve a desired product moisture content during the cooking process.

In another aspect described is a liquid cooking method where the corn is submerged in a water/aqueous bath, either plain water or with added ingredients (salt, surfactants, or other), held at an elevated temperature (140-215 F) by injection of steam, directly, or via steam jackets, agitated with high energy using an overrunning horizontal stirring blade/paddle mixer using new Pulse Technology which rotates down the length of the trough, with the speed of the mixing blade running faster than the turning rate of the product. This “overrunning” speed (usually 5 to 20 times the turning rate of the slurry) rapidly stirs up the product and maximizes the interface between the product and the cooking medium, thus resulting in high heat transfer rates and accelerated cooking.

In addition to high heat transfer, higher than normal infusion rates of the heating/cooking medium are also obtained by the mechanical action of the paddles (Pulse Technology) and stirring blades. These flat surfaces come in contact with the corn/product in its fully submerged status putting energy into its surface. This direct mechanical contact along with the pulse energy put into the medium by the paddle creates higher than normal infusion into the product surface. It is highly desirable to effect both a rapid temperature change in the product (Cooking) and transfer the cooking medium into the product (Infusion).

In another aspect, there is provided both a process “treatment” as well as an apparatus, whereby the method is a submerged, highly agitated water/aqueous solution transferring both heat and mass into the product, and apparatus utilizing the design of the mixing system to provide such a treatment. This allows for a continuous, very rapid, cooking of corn or other products.

Further aspects, features, and advantages of the present invention will be apparent to ordinary skill in the art upon examining the accompanying drawings and upon reading owing detailed description of the preferred embodiments.

### BRIEF DESCRIPTION OF THE DRAWINGS

FIG. 1 schematically illustrates an end view of an embodiment 1 of the inventive grain cooker mixing system and method.

FIG. 2 schematically illustrates an end view of the inventive grain cooker mixing system and method 1.

FIGS. 3a and 3b schematically illustrate end and side views of a prior art auger cooking system.

FIG. 4 illustrates the inventive grain cooking/hydration and flaking system.

FIG. 5 provides a side view of the inventive cooking system 1 and product path.

FIG. 6 illustrates a side view of the inventive zoned cooker with steam nozzles.

FIG. 7 illustrates an end view of the steam injection system for the inventive cooker 1.

FIG. 8 illustrates an end view of the water level control and make-up for the inventive 1.

FIG. 9 provides an end view of the inventive system 1 illustrating the inventive pulse technology.

FIG. 10 is a perspective view of a paddle/mixer assembly 8 used in the embodiments 1 and 100 of the inventive grain cooker mixing system and method.

FIG. 11 is a cutaway elevational side view of an embodiment 100 of the inventive grain hydration and cooking apparatus.

FIG. 12 is an elevational end view of the inventive grain hydration and cooking apparatus 100.

FIG. 13 is a perspective view of a feed assembly 102 used in the inventive grain hydration and cooking apparatus 100.

FIG. 14 is a cutaway elevational end view of a steam cooker assembly 104 used in the inventive grain hydration and cooking apparatus 100.

FIG. 15 is a perspective view of the steam cooker assembly 104.

### DETAILED DESCRIPTION OF THE PREFERRED EMBODIMENTS

In a conventional steam tower type system, corn, for example, enters the system at 14% moisture. After it is wetted, held for absorption, and steamed, the final moisture is 22%, or an 8% increase. Also, in the conventional method, a surfactant is added to sprayed-on water to reduce the surface tension between it and the grain surface thus causing more water to be absorbed. In contrast, our new system uses the same incoming corn at 14%, but can hydrate it as high as 26%, thus resulting in at least 50% more moisture infusion than conventional steam tower methods. Moreover, our process achieves this result in much less time, greatly reduces the amount of steam required, eliminates the need for and cost of adding surfactants, provides better moisture control, provides a more evenly cooked and consistent product, and greatly reduces the amount of in-process grain inventory required during operation.

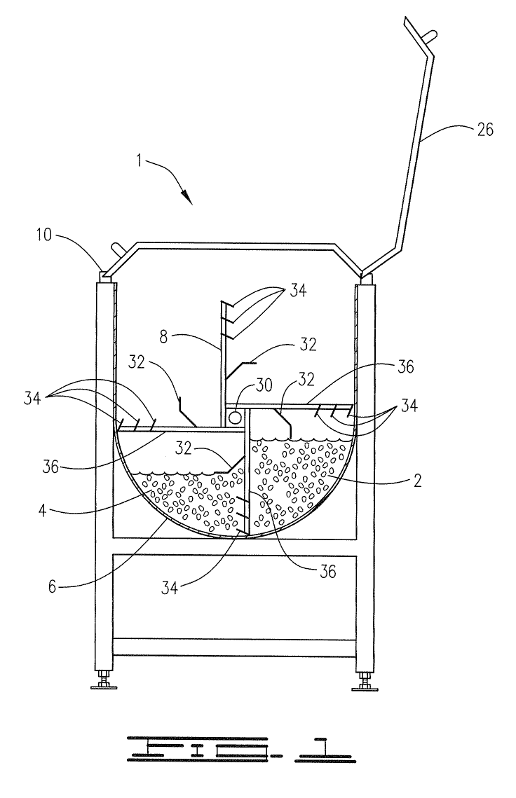

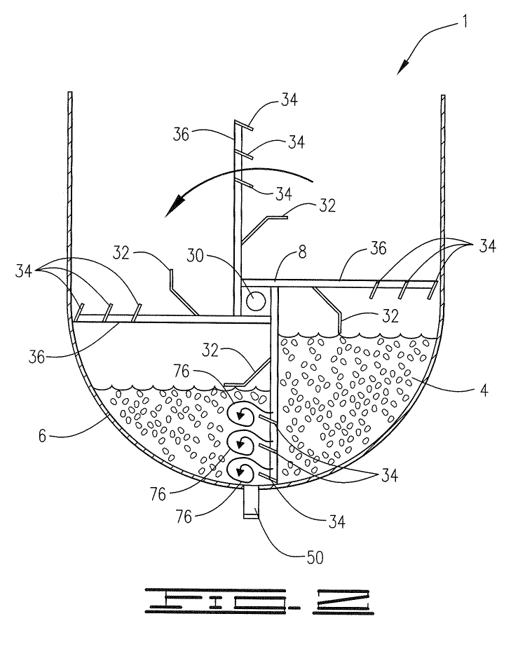

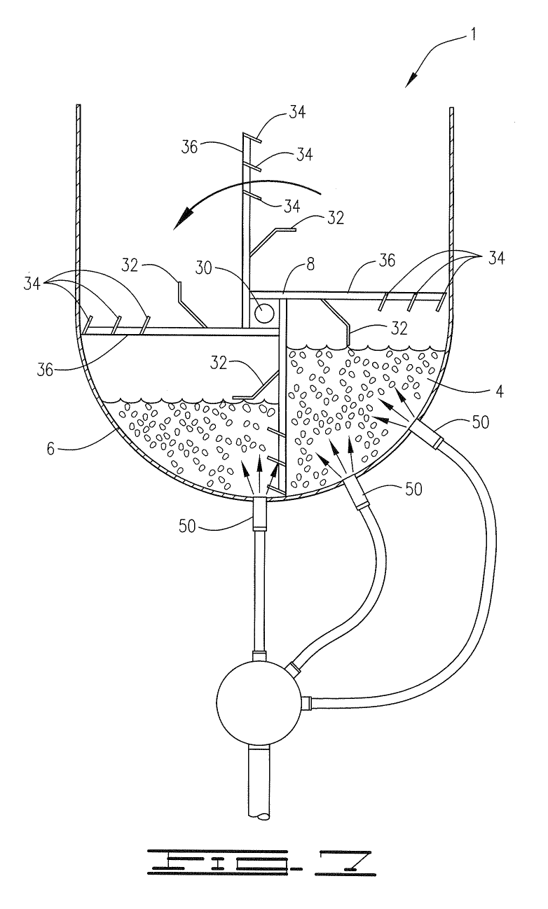

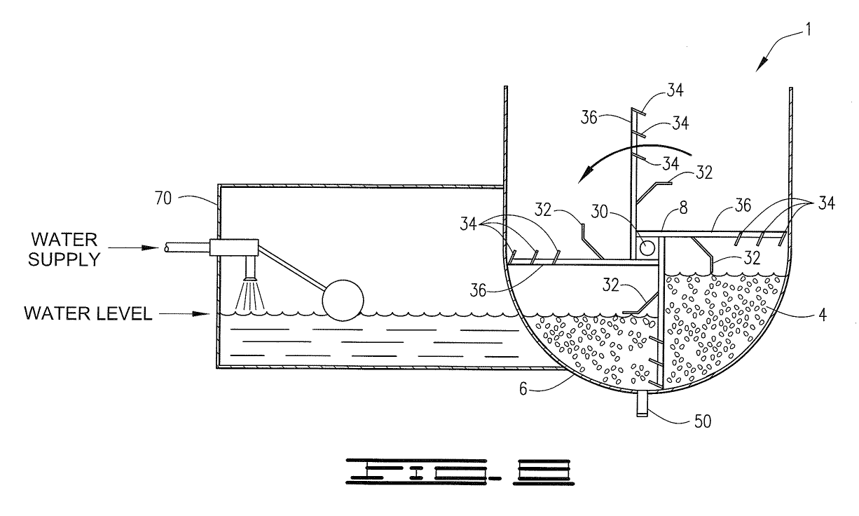

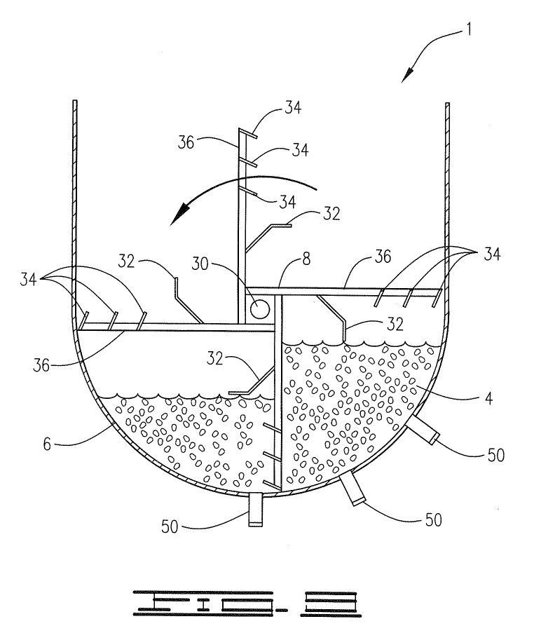

FIGS. 1, 2, and 4-9 show a first embodiment 1 of our new system being used in a new slurry version of the inventive process which involves placing the product (corn or other grains) 2 directly into a heated water (aqueous solution) bath 4 instead of surrounding it with steam. This is accomplished using a continuous horizontal water trough 6 equipped with a rotating paddle/mixer 8. This greatly increases the heat transfer into the product 2 over a conventional steam method due to total surface contact of the water. It also causes more of the medium to be infused into the product 2 without using a surfactant. Our new process does not require this since the water surrounds the product 2 in its submerged state.

Our method of submerged cooking in hot water prior to flaking is new to the industry. It allows for much shorter preparation/cook times of 5-10 minutes versus 180 minutes using conventional methods. It also eliminates the need for the costly surfactants, therefore reducing overall costs of production.

Adding steam directly into the water in the inventive method to raise the temperature is much more efficient than using conventional steam tower systems. We have found approximately 50% reduction in total steam requirements to cook the product in our system. Excess steam escaping from the surface of the cooking water is trapped by the cooking vessel 10 and directed down the product flow path and into the flaking rolls 12, thus helping to heat them and maintain their optimized operating temperature with very little waste steam escaping the system, maximizing the overall energy efficiency. In conventional steam tower systems, steam which is injected into the tower rises up through the falling grain flow and escapes at the top, resulting in lost energy and lower efficiencies.

Being totally submerged in an aqueous solution also allows for other ingredients to be added to the product 2. Our high energy agitation cooking method utilizing our newly developed Pulse Technology offers opportunities to further enhance grain value by infusion of certain essential nutrients during the cooking process. Putting new additives directly into the product 2 in this fashion can be used to create new products which improve ration digestibility, enhance rumem function, and ultimately improve animal value and welfare by changing carcass composition to favor attributes that are in greater demand by consumers. Infusion of other nutrients/additives into the grain in a conventional system would not be practical or efficient and would simply be washed away by condensing steam on the surface of the product.

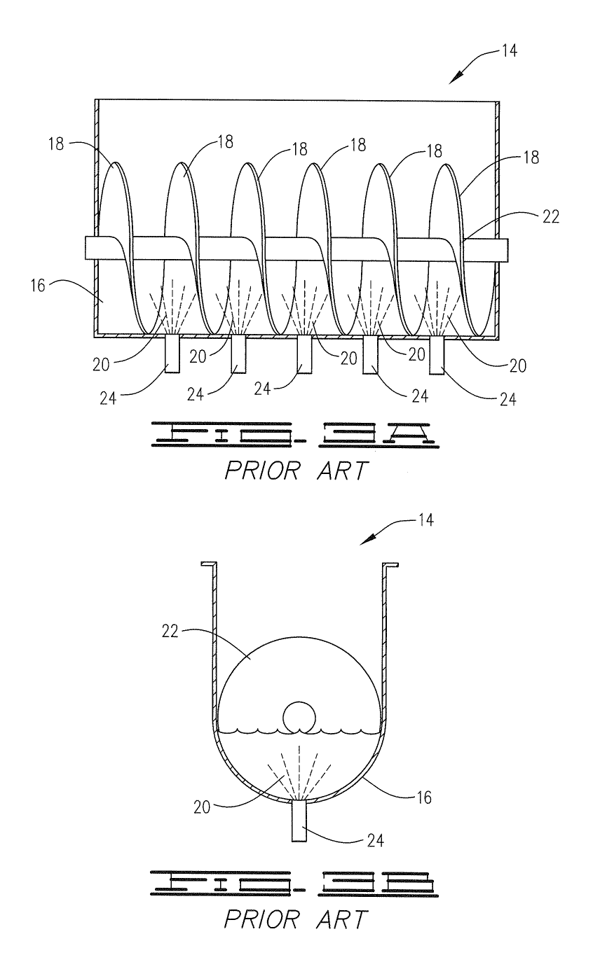

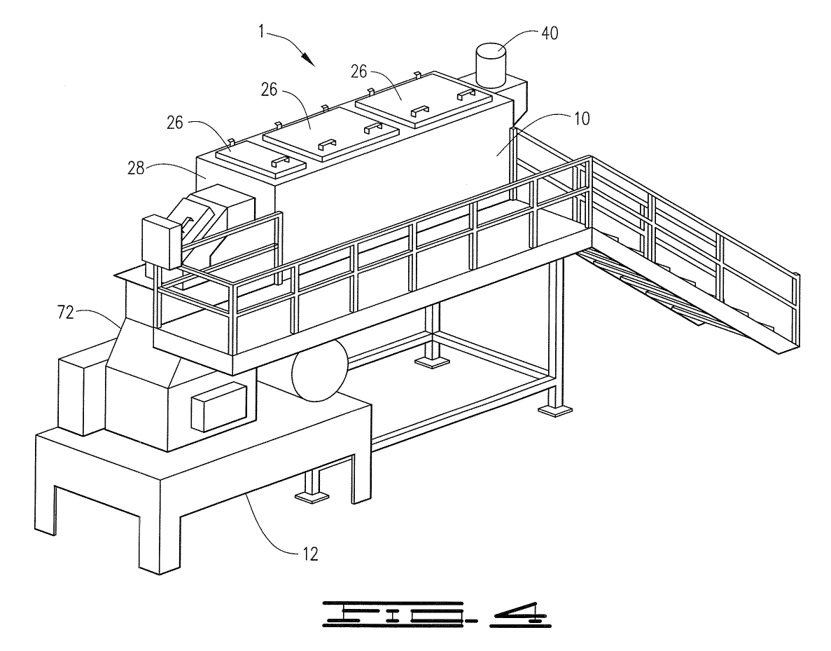

Our new submersion system preferably utilizes a continuous trough method but not a conventional auger system. As illustrated in FIGS. 3a and 3b, water cookers 14 currently used in other applications are typically auger based and used in many applications to control flow of product, gently pushing it down a trough 16 by rotating flights 18. Each of these flights 18 forms a chamber 20 in position along the length of that trough 16. The rotational speed of the auger 22 determines how fast those chambers 20 travel down that trough and how long the product is in treatment. If longer residence times are desired, the rotational speed of the auger 22 has to be very slow. Because of this, there is virtually no agitation obtained from the auger 22. Usually the product is either dry, semi dry, or suspended in a liquid solution. Steam is typically injected directly onto the product or into the heating medium (water) and used to modify the temperature of the solution and the product. It is usually brought into the chamber 20 by nozzles 24 from the lowest point on the trough 16 where the steam rises, causing bubbles to agitate the product and liquid, providing some mixing and local turbulence, thus improving heat transfer. To improve treatment, air bubbles are sometimes used to increase that turbulence and have a positive impact on the heat transfer. A mechanical mixing vane would be nice to have to increase the agitation and mixing, but cannot be placed within the confines of the chamber 16 due to the physical continuation of the flights 18 in their spiral fashion. Limitations therefore exist on how much heat transfer one can get from the self-agitating steam. The higher the amount of steam introduced into the water, the more agitation, however, absorption of that steam into the product might be limited, thus causing excessive amounts of steam to be non-utilized and wasted.

Therefore, although conventional auger cooking systems 14 are good for use in continuous submerged treatments, the screw auger 22 itself has limitations on being able to mechanically mix heat into the cooking medium and therefore into the product and is thus limited in its ability to move heat into the product.

In contrast, the inventive apparatus 1 illustrated in FIGS. 1, 2 and 4-9 is preferably a continuous type mixer, utilizing a metal (stainless steel) trough 6 with a top cover 26 and solid end caps 28, whereby, the product 2 is fed into one end, travels through and exits on the opposite end. The trough 6, top cover 26 and end caps 28 serve to contain both the product 2 and the steam. The elongate horizontal cooking vessel could alternatively be completely cylindrical (e.g., as in alternative embodiment 100 discussed below). A paddle/mixer shaft 30 is centered concentrically in the trough 6 and runs its entire length. It rotates about its horizontal axis 33, thus stirring the product 2, water, and steam which rests in the trough 6. As it turns, the paddle/mixer 8 does not propel the product down the length of the trough 6 like a conventional auger and has no positive means to push product except for a very slight ribbon spiral 35 on the outside edge. The purpose of this ribbon 35 is not to push product 2 when the trough is full, but to empty out the final small amount of grain when the trough is emptied at the end of the run and has little or no down trough conveyance while it is filled with product. That is done by incoming corn or other product 2 fed into the cooker 10 pushing other corn ahead of it down the trough 6, thus creating a plug flow regime.

The paddle/mixer element 8 preferably comprises: a plurality of (preferably 4) elongate swept-back paddles 32, each of which extends longitudinally along the length of the cooker trough 6; a plurality of (preferably four sets of three) elongate angled stirring blades 34 which extend longitudinally along the length of the cooker trough 6; and a plurality of sets/series (preferably four series) of radial or near radially extending support rods 36 for the longitudinally extending stirring blades 34.

The paddle/mixer system 8 has three basic functions. First, it stirs the slurry 4 (the tilted mixing-lifting vanes 34 create a high agitation of the solids in the cooking medium and also keep the steam mixed with the medium). Second, it puts pile turning and “Pulse” energy into the slurry 4 (the paddle portion 32 of the vanes serves to put a pulse energy into the cooking medium which helps to maintain a consistent temperature throughout and “compresses” the bulk of the solid mass, thus increasing the density and therefore the heat transfer. The paddles 32 also serve to strike the surface of the solids putting additional kinetic energy into that surface and creating a domino effect of the solids within the slurry. At a rotational speed of 42 rpm, the four paddles 32 impart 168 beats per minute. This pulsing serves to send motion and energy waves throughout the body of the slurry 4 which greatly increases heat transfer). Third, the paddle/mixer system 8 empties the final small amount of product at the end of the run. The pulse rate is typically in the range of 100 to 200 pulses per minute.

The product 2 can be dry, semi-dry, or in a slurry with various ratios of solids to liquids. An example of a non-slurry procedure using the alternative embodiment 100 of the inventive system is discussed below. It will be understood, however, that any desired slurry or non-slurry procedure can be performed using either of the inventive systems 1 or 100.

For the slurry procedure, a 1:1 ratio (volume) of solids to water will typically be used. The product resting in the round bottom trough 6 of the cooker 10 turns over as it is mixed. The paddle/mixer 8 rotating speed “overruns” the turning speed of the solids at a rate of 2 to 10 times. This causes much turbulence in the body of the turning solids thus creating a very even mixing of the incoming steam into the heating medium and of the heating medium to the solids. It serves to create a very high interface of that medium to the solids and causes the temperatures to be very close to the same of both materials. Because both temperatures are very close to the same, there are no “cold” spots within that interface, thus causing very high consistency in the surface temperature of the solids (corn). This consistent high surface temperature maximizes even heat transfer into the body of the solid pieces, thus causing a high rate of cooking.

The total process time, cooking/infusion, of this new method is typically 5 minutes. The cook is achieved by the over running of the paddle/mixer 8 to that of the slurry mix. This overrunning method stirs up the solids in that cooking medium and also stirs up the incoming steam resulting in a cooking medium that is very consistent in temperature at any point in the trough 6. As the product surface draws in heat, it cools the surrounding water (taking in heat), the high stirring action removes that cool water (boundary effect) and replaces it with “set point” hot water. That same stirring action helps to integrate the steam that is injected into the cooking water and mixes it up to maintain consistent temperatures. This keeps the temperature of the water in contact with the surface at set point temperature and thus maximizes heat transfer into that surface. This is the reason the inventive process can cook corn in the 5 minute time frame versus 60 minutes in a steam tower.

In addition to the high heat transfer rates into the surface, the inventive process is also able to obtain very high infusion rates. This is due to the Pulse energy created by the paddles 32 and also the direct mechanical contact of them to the surfaces of the product. Typically in conventional systems, the total moisture uptake from pre-wetting, soaking and steam cooking is from 14% initially to a final of 22% or approximately an 8% increase. This total treatment requires approximately 180 minutes. In the inventive treatment of 5 minutes, the moisture starts at 14% and exits the cooker at approximately 26% or a 12% increase. The added moisture over conventional steam cooked corn is about a 50% increase with a 3600% decrease in treatment time.

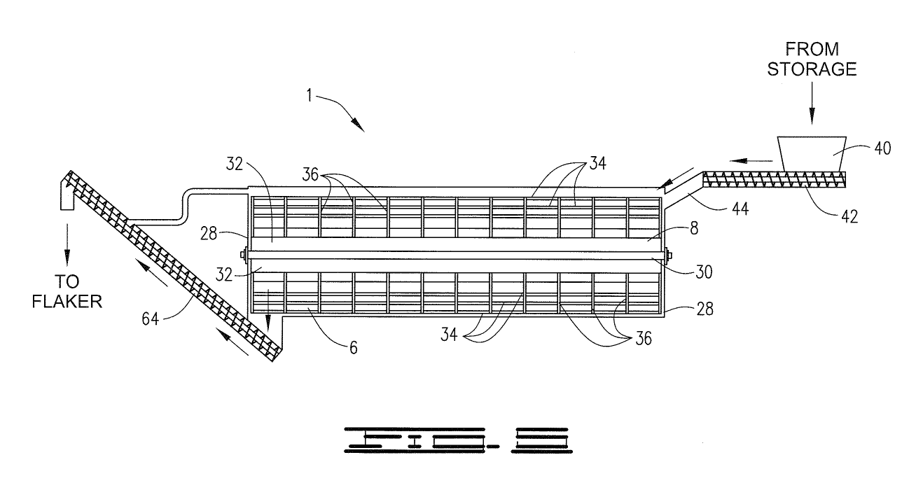

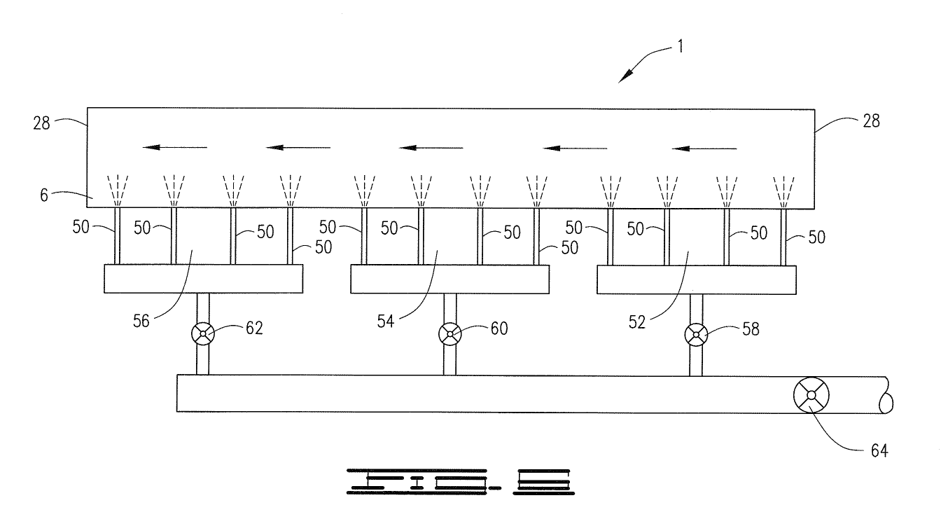

Referring to the corn cooking product path illustrated in FIGS. 4 and 5, grain is brought directly from on-site dry storage into the system on a continuous basis (typically as much as 16,000 lbs/hr-finished or more) into the surge hopper 40 of the in-feed screw 42. It is desirable for the corn to be pre-cleaned, but is not absolutely necessary, as the cooker will flow a certain amount of “trash” (cob and stalk pieces, etc.) without problems. It will also flow small stones, but they should be removed prior to the flaker 12 as not to damage the grooved rollers. The corn moisture level is not critical because the cooker will place as much moisture into the corn as it will take. For example, high moisture corn (16+%) enters the cooker and will absorb 9% moisture, where low moisture corn (10%) will absorb 15% moisture, if a 25% final moisture target is desired.

The screw 42 is variable speed and serves to meter, by volume, the incoming product. This could also be a “Loss in Weight” scale or a volumetric displacement method, but will typically be preferred a screw auger. The main computer controls the speed, using an inverter on the 3 phase drive motor of the screw 42, based on the production requirements of the run. As the moisture is measured at the entrance into the flaker, data is sent back to the controller to reduce the flow rate to compensate for the added moisture. For example, the operator measures the moisture of the incoming corn at 14% and inputs that into the master controller/computer. The moisture monitoring system reads final moisture at the entrance of the flaker at 25% and sends that data to the computer. Here the computer calculates that 11% has been added and compensates the infeed rate down to 14,560 lbs input to provide for 16,000 lbs/hr output.

The entire screw 42 is closed and mounted to the end plate 28 of the main cooker body. This allows for containment of the steam which would be present in the cooker. That escaping steam also serves to pre-heat the incoming product, but is not a requirement of the system, just a bonus. The grain falls down a transfer chute 44 into the rotating paddle/mixer 8 in the cooker and is incorporated into the slurry. Incoming product serves to “push” product down the length of the cooker and is the only means necessary to propel product 2 through the cooker.

Product plug flows down the length of the cooker 10. The in-feed rate is metered and consistent. After the in-feed begins, the control computer starts a timer based on the cook time of the product. During this time, grain is fed into the cooker and fills it up. At the completion of that time requirement, the take-out system begins to take grain out at a metered, consistent rate. This gives the grain the required cook time in the cooker. The designs of the lifting bars 34 and the paddles 32 are such that no product is propelled down the cooker 10 except by product up-line, which produces the “plug-flow” regime. There is a small continuous spiral band 35 on the outside of the paddle-mixer 8, but has little or no pushing effect on the mass in the cooker 10. Its purpose is to remove the small amount of grain left in the cooker when it is emptied at the end of the run.

Steam is injected into the trough by steam nozzles/orifices 50, which are located, below water level, in 2, 3, or 4 rows along the length of the cooker. (As used herein and in the claims, the term “steam injection nozzle” refers to and encompasses any type of nozzle and/or orifice structure or arrangement.) This provides adequate steam to heat the water to hold cooking set point temperature. The steam requirements are different than those of conventional steam chests which require much higher operating pressures (70-100 psi steam). The inventive system can deliver steam to the water with as low as 20 psi pressure and still provide the necessary water temperature. This allows the boiler to operate at a lower pressure.

The cooker 10 is divided into three sections or zones 52, 54, and 56 where the temperature, via the steam metering valves 58, 60, and 62, can be modified for each zone. This allows the operator to cook at from 1 to 3 different water temperatures. Each zone has its own manual steam control valve 58, 60, or 62 to meter the amount of steam entering into that set of steam orifices 50. The set of orifices for that zone are matched at the factory to provide even steam flow. The general flow for each zone 52, 54, and 56 is regulated by the zone steam control valve 58, 60, or 62.

The total incoming steam flow to all zones is regulated by the automatic master steam control valve 64, with its temperature sensor mounted in the first zone 52, which is always the coldest in terms of heat load. The main purpose of the main control valve 64 is to modulate the total steam flow. This controls the temperature of the water but also the amount of excess steam sent to the cooker 10. When the water reaches boiling point, additional steam exits the water as excess steam and is captured in the space above the water. The cabinet 10 is covered by lids 26 and prevents steam from escaping. This provides for a head space and means for that excess steam to travel down the length of the cooker 10, through the take-out screw 64 and down onto the flaking rolls 12. This assists in keeping the flaking rolls 12 warm, which helps to form optimum flakes. Since the rolls 12 assist in the gelatinization process of the corn, temperature is important and can impact flake performance. It is important especially at start up when the rolls 12 are cold or cool.

The purpose of the cooker is to put both heat and water (or whatever the medium is) into the product 2 in order to cook it to a required endpoint, which is typically to an internal temperature of 200 F (core) or above. A standard cook to duplicate conventional steam chest quality would use a water temperature of 210 F in the first zone 52, 210F in the second zone 54, and 205 F in the third zone 56. This allows for the product to be cooked to a gelatinous ready state for the pressing that occurs at the rollers 12. By submersion in water (or other), infusion naturally occurs into the body of the product. Additional infusion is obtained by the interface of the product 2 to the paddles 32 and lifting bars 32 located on the paddle-mixer 8. The heat and water soften and hydrate the grain. A visual proof of this condition is to inspect the corn (yellow dent) and see the “dent” has disappeared. Note that having the capabilities to “zone” cook allows for improved pre-conditioning of the corn. Zone cooking also helps both with finer conditioning of the corn itself and supports the new the addition of additives and their requirements for nutrition and other purposes.

Control variables in the cooker include the following:
1. Residence time in the cooker
2. Zone temperatures
3. Water Level
4. Medium utilized-water or other (water and surfactants, acids, salts, nutrients, enzymes . . . or others)
5. Steam (this is either to water temperature setpoint, or excess steam for heating the rolls)
6. Paddle-Mixer Speed

The water level in the cooker 10 is maintained by a level control 70 and feed tank which is located at the in-feed end of the cooker. This also serves to fill the cooker 10 at start-up with water, and to flush the cooker at the end of the run. Since the corn is absorbing water during the cook at the rate of 4 to 16%, or more, it is preferred to continually add water and maintain level control in the cooker 10.

Product can be removed from the cooker 10 in one of at least two ways. A take out wheel which incorporates cavities can remove, by volume, product from the take-out end of the cooker 10. Its speed is controlled by the computer to meet take-out requirements of the production run. When the grain is removed, excess water is removed as well. This is separated by a screen and returned to the cooker water.

Another method uses an auger 64 mounted below the level of the cooker 10. As product travels to the end of the cooker, it falls into the feed cavity of the take-out screw auger and is transported out to the flaker 12 in-feed. In this case, excess water is shed or removed from the product 2 by the action of the product 2 being transported in the screw action of the auger 64. The excess water runs back into the grain, keeping it hot and moist for the flaking operation. The speed of either the auger or wheel is calibrated for pounds displaced and controlled by the main control computer to meter grain removed from the cooker 10.

All steam is contained with the cooker 10. Any excess steam is directed out of the cooker 10 at the take-out end and down the flaker feed hopper 72 into the rolls 12 and serves as a heat source for start up heating of the rolls 12.

A combination moisture sensor and grain temperature monitor is mounted at the exit end of the take out auger 64 to monitor moisture and temperature of the finished cooked product prior to flaking. This information is fed back into the computer to provide data for controlling the cook. Target moisture and temperature parameters, which the operator enters into the control system, are maintained by controlling variables within the cooker to meet those requirements.

The product can be flaked using conventional flaking rolls 12. The operation of the flaker is monitored with adjustments in the gap between the rollers. The target product is a complete flake with a density between 25 and 28 lbs/bushel. This is a manual measurement using a density cup. Adjustments in both the cooking and the flaker impact the final product condition. The cooker is designed to automatically cook product to a final temperature and moisture at the designated production rate. The operator uses the adjustable parameters in both the cooker 10 and on the flaker 12 to obtain the optimum final product. Samples are also taken and lab analyzed to determine degree of gelatinization. An in-line moisture meter such as Hydronix Model ORB1 measures the product temperature and moisture levels as product flows over its sensor and into the flaker 12. We have used this method on prototype equipment with good success. It sends out digital data in real time to the computer/controller with moisture and temperature levels.

This cooking method yields a much more consistent, kernel to kernel, end product than in a steam tower. This is due to the product being submerged in a very even temperature medium and seeing much more consistent treatment. It also offers the ability to infuse more moisture into the product, which impacts the flake integrity and performance, not to mention the added weight. With the gelatinization, moisture, density, and flake integrity the operational targets, this automatic cooking systems offers the operator a more predictable end product, not to mention the 50% energy savings over conventional steam cooking systems.

Pulse Technology is a new and inventive concept for improving heat transfer. It is based on the concept of “bouncing” the molecules closer together to improve electron spin sharing, i.e., heat transfer. This is accomplished using a pulsing energy imposed on the mass of the grain, whether in slurry or non-slurry form, by the multi-bladed paddle 8. Each blade 32 displaces the grain or the liquid/solid mix 4 for a fraction of a second and then retracts. This allows for kinetic energy to be placed on the grain/slurry 4 without substantial flow or movement. This motion is just enough to cause the molecules in an incompressible fluid, like the slurry 4, to “press” against each other and move closer together. This molecular “pressure” induces higher heat transfer between molecules without causing movement of the slurry 4.

The intent of the pulsing is to impart kinetic energy, motion, into the mass (slurry or non-slurry) 4 without causing a general flow of that mass. The blade 32 of the paddle 8, in its rotating motion and sweeping design, does this by pushing against the mass and then retracting from that mass. This causes the static inertia of the molecules to hold them in place while adjacent molecules “bounce” into them, causing them to get closer together, closer than they normally would in a flow type regime. This “closer than normal” position causes more induced electron spin sharing than normal, i.e., higher heat transfer than normal.

In addition to the use of this inventive technology in, e.g., a water-corn slurry, it also has application in any other fluid systems, either gas or liquid. The concept of imparting momentary, pulsed energy can be applied to either a compressible or incompressible system. In the above-described liquid application, the corn kernels (or any grain, vegetable, or fruit) are suspended in a liquid and are stirred in that suspension by a rotating member, using lifting bars 34 that are continuous along the length of the cooking chamber 10/trough 6. In a non-slurry process, the grain mass is stirred by the lift bars 34 in the same manner.

The bars 34 are pitched at an angle of 5 to 30 degrees (15 degrees in this application) and serve to move the position (up in this case (leading edge away from the axis of rotation), but could be up or down) of the solids as the bar 34 moves past them. As the bar 34 continues on its rotation and out of the area, the solids are drawn back into position by the response of the body (e.g., the liquid eddy 76) and this “stirs” the solids. The preferred speed of the paddle mixer 8 unit is 42 rpm. With four sets of blades 34 per revelation, this mixing occurs 168 times per minute or 2.8 times per second.

In the slurry process, for example, this is a good method of transferring heat from the medium (water) to the solids by reducing the boundary layer effect of liquid surrounding the solid as it is quickly moved and rotated within its suspension. This supports the goal of maintaining the highest temperature water at the surface of the corn for maximizing the heat transfer. This also serves to mix the steam into the water for the highest interface of gaseous steam to liquid water, also maximizing the condensation of steam, i.e., heat transfer into the water. The lifting bars 34 alone would serve as a good mixing method to cook the product and provide the required cooking treatment in a very short time frame of 10 to 15 minutes.

The paddles 32, which are shown in the drawings, also run the entire length of the cooking chamber 10/trough 6. In this configuration, four individual paddles 32 make up the entire paddle system, but could be easily changed to more or less, depending on the requirements of the pulsing. The speed of the paddle system is preferably approximately 42 rpm which imparts 168 pulses per minute or 2.8 pulses per second onto the body of the water/corn slurry 4. The paddles 32, causing a pulsing kinetic energy, serve to cause the molecules of all the mass in the slurry to move closer together. This improves heat transfer between the steam and the water, improving condensation of the steam and providing more utilization of that steam for heating of the water. It also improves the heat transfer between the hot water and the corn, thus causing the corn to cook faster. It also causes the infusion of the water to increase, due to the increased pressure that is imparted on the surface of the corn by the water. This is the main reason the inventive system can almost double the water pick up in the corn (14% initial moisture to 25% final moisture) in a very short time frame (5 minutes) versus the 3 hour time frame of a conventional steam chest system (14% initial moisture to 20%, aided by surfactants).

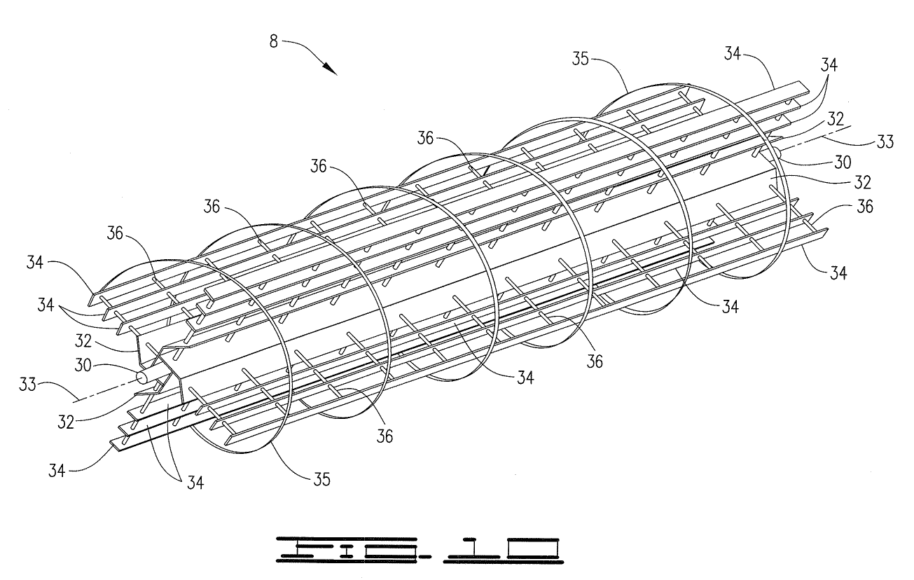

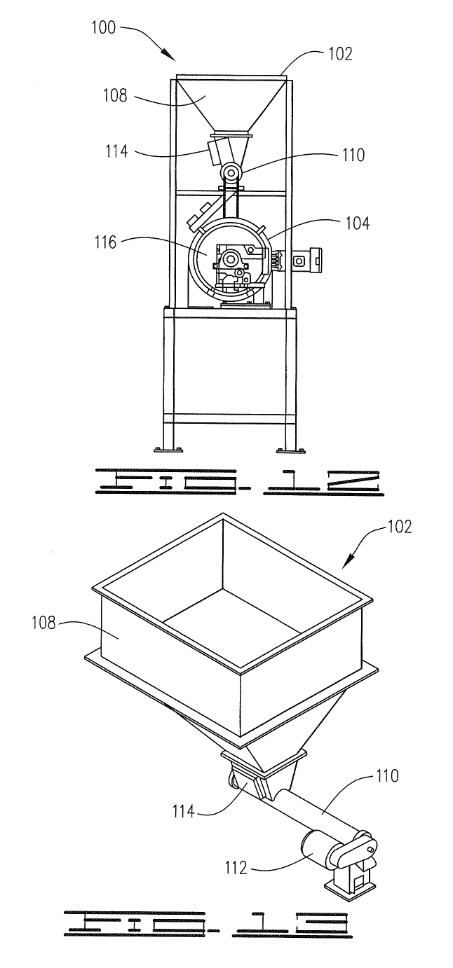

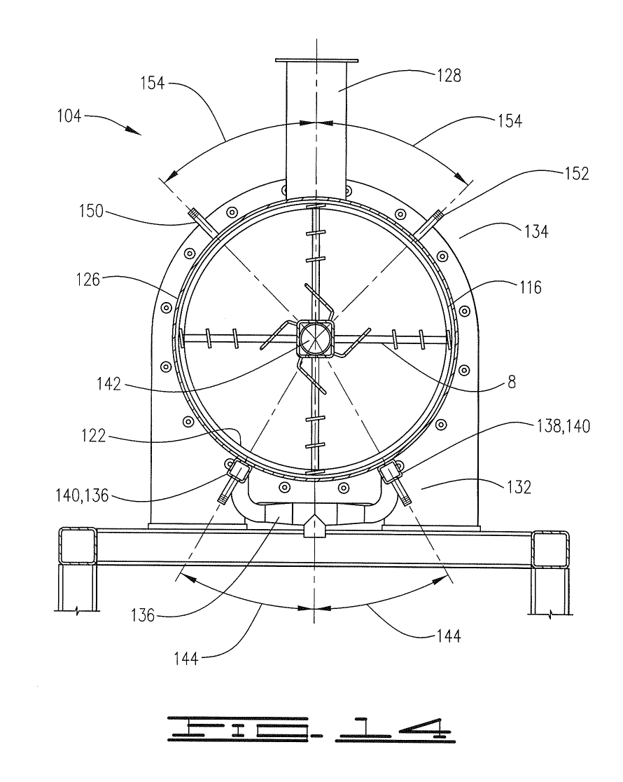

Another embodiment 100 of the inventive grain hydration and cooking apparatus is illustrated in FIGS. 10-15. The inventive apparatus 100 comprises a feed assembly 102, a steam cooker assembly 104, and a product output assembly 106. As with the inventive apparatus 1, the inventive apparatus 100 can be used for hydrating and cooking corn or generally any other type of grain. In addition, as is also the case with inventive system 1, the grain processed in the inventive apparatus 100 can be conducted through the steam cooker assembly 104 of apparatus 100 in non-slurry, slurry, or semi-slurry form. Moreover, we have discovered that the results provided by the inventive apparatus 100 for the non-slurry hydration and cooking procedure for corn or other grains are even superior to the results provided by the slurry hydration and cooking procedure conducted as described above using the inventive apparatus 1.

The feed assembly 102 of the inventive apparatus 100 comprises: a feed hopper 108 for receiving and holding the feed grain (preferably dry grain); a feed auger 110 for conveying the grain from the feed hopper 108 to the steam cooker assembly 104; a feed auger drive motor 112; and a moisture meter 114 preferably mounted between the discharge of feed hopper 108 and the inlet of the feed auger 110.

The steam cooker assembly 104 of the inventive apparatus 100 preferably comprises a cylindrical cooking drum 116 having a paddle and mixer assembly 8 rotatably mounted therein of the same type which is preferred for use in the inventive apparatus 1 (see, FIGS. 1, 2, 5, and 7-10). The longitudinal ends 118 and 120 of the cylindrical cooking drum 116 are preferably flat and the cylindrical shape of the cooking drum 116 provides a rounded interior bottom 122 within the drum similar to the rounded interior bottom of the trough 6 used in apparatus 1.

The cylindrical steam cooker assembly 104 preferably also comprises: at least one layer of insulation (e.g., glass foam insulation) 124 covering the exterior of the cylindrical cooking drum 116; a thin outer stainless steel skin (e.g., 10 gauge stainless steel) 126 installed over the insulating material 124; a gravity feed inlet nozzle 128 provided through the top side of the inlet end of the cooking drum 116; and a cooked product gravity discharge nozzle 130 provided through the bottom side of the discharge end of the cylindrical cooking drum 116.

The steam cooker assembly 104 of the inventive system 100 further comprises (a) a steam injection system 132 for injecting steam upwardly into the bottom of the cylindrical cooking drum 116 and (b) a water injection system 134 which preferably injects water downwardly into the cooking drum 116. The steam injection system 132 preferably comprises a steam inlet manifold 136 which provides steam to a pair of elongate steam headers 136 and 138 which extend longitudinally along the bottom of the cooking drum 116. The steam headers 136 and 138 each include a series of steam injection nozzles 140 and are positioned on opposite sides of the bottom of the cooking drum 116.

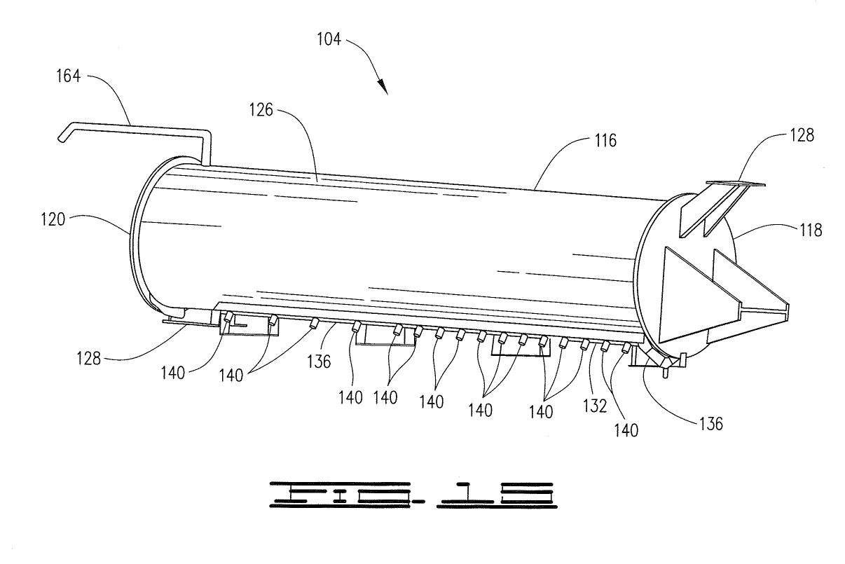

As illustrated in FIG. 14, the steam nozzles 140 are each preferably positioned for injecting steam toward the longitudinal axis (i.e., the centerpoint) 142 of the paddle and mixer assembly 8 at an angle 144 which is in the range of from about 10° to about 40° from perpendicular. The angle of steam injection 144 on each side of the bottom portion of cooking drum 116 is more preferably in the range of from about 15° to about 35° and is most preferably about 30° from perpendicular.

In addition, as illustrated in FIG. 15, each of the steam headers 136 and 138 preferably includes more injection nozzles extending along the first half of the cooking drum 116 closest to the grain feed end 118 than are provided along the second half of the steam header 136 or 138 closest to the grain outlet end 120. Consequently, the nozzles 140 are spaced closer together along the first half of the cooking drum 116 than along the second half. The closer spacing distance between the nozzles along each header 136 and 138 adjacent to the grain feed end 118 of the cooking drum 116 is preferably in the range of from about 0.35 to about 0.75, more preferably from about 0.4 to about 0.7, times the longer spacing distance between the nozzles 140 closest to the drum discharge end 120.

The water injection system 134 comprises at least one pair of water injection nozzles 150 and 152 which are preferably positioned on opposite sides of the top portion of the drum at the grain feed end 118. The nozzles 150 and 152 are preferably operable for injecting water downwardly into the interior of the drum. As illustrated in FIG. 14, the opposing pair of water injection nozzles 150 and 152 are preferably positioned and oriented adjacent to the inlet end 118 of the cooking drum 116 such that the nozzles 150 and 152 will spray or otherwise deliver water toward the center 142 of the paddle and mixer assembly 8 at an angle 154 which is in the range of from about 15° to about 60° from vertical. The angle 154 is more preferably in the range of from about 25° to about 50° and is most preferably about 45° from vertical. If desired, one or more additional water injection nozzles or opposing pairs of water injection nozzles can be provided along the longitudinal top portion of the cylindrical cooking drum 116 or at any desired location(s).

The locations and orientations of the steam and water injection nozzles 140, 150, and 152 and the spacing of the steam nozzles 140 are particularly well suited for processing dry grain products which are not delivered through the cooker 116 in slurry form. The steam nozzle and water injection arrangements shown are particularly well suited for hydrating and cooking grains which are delivered to the cooking drum in dry form for processing in accordance with the inventive non-slurry procedure.

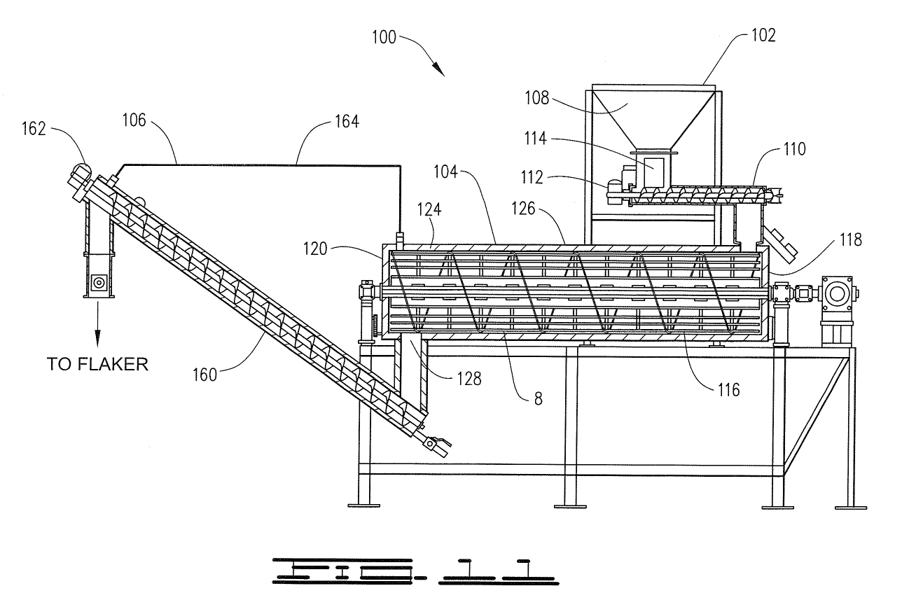

The cooked product output assembly 106 of the inventive apparatus 100 comprises a takeout auger 160 and an auger motor 162. In the embodiment of the inventive system 100 shown in FIG. 11, the takeout auger 160 receives the cooked grain product from the cooking drum discharge nozzle 128 and then carries the cooked grain product upwardly at an angle for delivery into the top of a flaking apparatus. It will be understood, however, that the takeout auger 160 can be positioned and oriented in any manner as may be needed for delivering the cooked product from the cooking drum 116 to a flaker or other processing apparatus.

A steam vent line 164 preferably also extends from the top of the cooking drum 116 at the discharge end thereof for venting steam from the cooking drum 116 into the discharge end of the cooked product output assembly 106. The vent 164 functions both to maintain the desired operating pressure within the cylindrical cooking drum 116 and to cause the vented steam to be delivered to and used for heating the flaking apparatus.

Regardless of whether the corn or other grain delivered through the inventive system 100 is hydrated and cooked therein in a slurry form or in a non-slurry form, the flow rate of the grain product through the inventive system 100 is controlled by the operation of the feed auger 110 and takeout auger 160 in the same manner as described above for the inventive system 1. As will also be understood, drag conveyors or belts or other grain handling systems can alternatively be used in the inventive systems 1 and 100 in place of the feed and product auger assemblies shown.

As mentioned above, we have discovered that the inventive system 100 is particularly well suited for hydrating and processing corn and other grains using a non-slurry procedure wherein (a) the feed grain material is delivered into the cooker feed nozzle 128 in a nonsuspended, non-slurry form and (b) the grain is preferably only contacted with a sufficient amount of water such that the water and the steam used in the cooking process are sufficient to achieve the targeted moisture content for the cooked product. The water applied to the grain material to achieve the desired final moisture content can be applied within and/or at generally any point prior to the cooking drum 116. However, the water will preferably be injected either within the cooking drum 116, between the feed hopper 108 and the cooking drum 116, or a combination thereof. The contacting water will most preferably be applied to the grain via the cooking drum water injection ports 150 and 152. In addition, as with the inventive slurry cooking procedure described above, other beneficial ingredients and additives can be included in the contacting water used in the non-slurry process for infusion into the grain product.

In both the inventive non-slurry procedure and the inventive slurry procedure, the mixing blades 34 of the paddle mixer assembly 8 travel beneath the surface level of the grain mass in the rounded bottom portion 122 of the cooking vessel 6 or 116 to lift and mix the grain material. Likewise, in both the inventive non-slurry procedure and the inventive slurry procedure, the paddles 32 impact and displace the grain mass surface level. Thus, in the inventive non-slurry procedure, the mixing and pulse operation of the rotating paddle and mixer 8 assembly works in much the same manner as in the slurry procedure to accelerate, increase, and optimize each of the cooking, moisture pickup, and heat infusion processes occurring in the steam cooker assembly 104. In addition, the inventive non-slurry procedure also works to provide even greater control over the final product moisture content. Moreover, the inventive non-slurry procedure does not require the use of surfactants and also matches or improves upon all of the other benefits, efficiencies, and advantages of the inventive slurry procedure.

Thus, the present invention is well adapted to carry out the objectives and attain the ends and advantages mentioned above as well as those inherent therein. While presently preferred embodiments have been described for purposes of this disclosure, numerous changes and modifications will be apparent to those of ordinary skill in the art. Such changes and modifications are encompassed within this invention as defined by the claims.

What is claimed is:

1. An apparatus for preparing grain for animal ingestion comprising:
an elongate cooking vessel including a rounded interior bottom portion, a grain feed inlet end, and a grain product outlet end;
a plurality of steam injection nozzles for injecting steam into said cooking vessel; and
a plurality of elongate mixing blades extending longitudinally in said cooking vessel, said mixing blades being mounted for rotation in said cooking vessel such that said mixing blades will travel beneath a grain surface level in said cooking vessel when rotated through said rounded interior bottom portion.

2. The apparatus of claim 1 wherein each of said mixing blades has a first end adjacent said grain feed inlet end of said cooking vessel and a second end adjacent said grain product outlet end of said cooking vessel.

3. The apparatus of claim 2 comprising at least two sets of said mixing blades wherein each of said sets comprises one of said blades positioned furthest from a rotational axis of said mixing blades and a second of said blades positioned between said one blade and said rotational axis.

4. The apparatus of claim 3 wherein each of said sets comprises a third one of said blades positioned between said second blade and said rotational axis.

5. The apparatus of claim 2 wherein said mixing blades have a direction of rotational travel around a rotational axis and each of said mixing blades has a leading edge in said direction of rotational travel and said leading edge is angled away from said rotational axis.

6. The apparatus of claim 5 wherein said leading edge of each of said mixing blades is angled in the range of from about 5° to about 30° away from said rotational axis.

7. The apparatus of claim 1 wherein said cooking vessel is cylindrical.

8. The apparatus of claim 7 wherein said steam injection nozzles are positioned in two rows along a bottom portion of said cooking vessel such that said steam injection nozzles will deliver steam upwardly into said cooking vessel toward a rotational axis of said mixing blades at an angle in the range of from about 15° to about 35° from vertical.

9. The apparatus of claim 1 further comprising a plurality of elongate paddles extending longitudinally in said cooking vessel, said paddles being mounted for rotation in said cooking vessel such that said paddles will impact and displace said grain surface level when rotating toward said rounded interior bottom portion.

10. An apparatus for preparing grain for animal ingestion comprising:
an elongate cooking vessel including a rounded interior bottom portion, a grain feed inlet end, and a grain product outlet end;
a plurality of steam injection nozzles for injecting steam into said cooking vessel; and
a plurality of elongate paddles extending longitudinally in said cooking vessel, said paddles being mounted for rotation in said cooking vessel such that said paddles will impact and displace a grain surface level in said cooking vessel when rotating toward said rounded bottom portion.

11. The apparatus of claim 10 wherein each of said paddles has a sweptback lateral cross-sectional shape.

12. The apparatus of claim 10 wherein each of said paddles has a first end adjacent said grain feed inlet end of said cooking vessel and a second end adjacent said grain product outlet end of said cooking vessel.

13. The apparatus of claim 10 further comprising a plurality of elongate mixing blades extending longitudinally in said cooking vessel, said mixing blades being mounted for rotation in said cooking vessel such that said mixing blades will travel beneath said grain surface level in said cooking vessel when rotated through said rounded interior bottom portion, wherein said paddles and said mixing blades have a common rotational axis and said paddles are positioned closer than are said mixing blades to said rotational axis.

14. The apparatus of claim 10 wherein said cooking vessel is cylindrical.

15. The apparatus of claim 14 wherein said steam injection nozzles are positioned in two rows along a bottom portion of said cooking vessel such that said steam injection nozzles will deliver steam upwardly into said cooking vessel toward a rotational axis of said paddles at an angle in the range of from about 15° to about 35° from vertical.

16. An apparatus for preparing grain for animal ingestion comprising:
an elongate horizontal cooking vessel including a rounded interior bottom portion, a grain feed inlet end, and a cooked grain outlet end and a rotatable mixing and impacting assembly extending longitudinally in said horizontal cooking vessel, said rotatable mixing and impacting assembly comprising
(i) a rotatable elongate center shaft extending substantially from said grain feed inlet end to said cooked grain outlet end,
(ii) a plurality of elongate mixing blades which rotate with and extend substantially parallel to said center shaft, said mixing blades being spaced a sufficient distance from said center shaft such that said mixing blades will travel beneath a grain surface level in said horizontal cooking vessel when rotated through said rounded interior bottom portion, and
(iii) a plurality of elongate paddles which rotate with and extend substantially parallel to said center shaft, said paddles being positioned closer to said center shaft than are said mixing blades such that said paddles will impact and displace said grain surface level when rotating toward said rounded interior bottom portion.

17. The apparatus of claim 16 wherein said horizontal cooking vessel is cylindrical.

18. A method of preparing grain for animal ingestion comprising the steps of delivering said grain through and cooking said grain in an elongate cooking vessel having a mixing and impacting assembly rotating therein, said mixing and impacting assembly extending longitudinally in said cooking vessel and said mixing and impacting assembly comprising:
an elongate center shaft which is rotating in said cooking vessel;
a plurality of elongate mixing blades which are rotating with and which extend substantially parallel to said center shaft, said mixing blades being spaced a sufficient distance from said center shaft such that said mixing blades stir said grain by traveling beneath a grain surface level in said cooking vessel when rotating through a rounded interior bottom portion of said cooking vessel; and
a plurality of paddles which are rotating with and which extend substantially parallel to said center shaft, said paddles being positioned closer to said center shaft than are said mixing blades such that said paddles impact and displace said grain surface level as said paddles rotate toward said rounded interior bottom portion.

19. The method of claim 18 wherein each of said mixing blades has a first end adjacent said grain feed inlet end of said cooking vessel and a second end adjacent said cooked grain outlet end of said cooking vessel.

20. The method of claim 19 wherein each of said paddles has a first end adjacent said grain feed inlet end of said cooking vessel and a second end adjacent said cooked grain outlet end of said cooking vessel.

21. The method of claim 18 further comprising the step of maintaining desired cooking temperature conditions in said cooking vessel by injecting steam into said cooking vessel.

22. The method of claim 21 wherein said cooking temperature conditions are maintained by injecting said steam into said rounded interior bottom portion at a plurality of locations along said cooking vessel.

23. The method of claim 18 wherein said grain is delivered through said cooking vessel in an aqueous slurry form.

24. The method of claim 23 wherein said grain in said aqueous slurry form is continuously pushed through said cooking vessel from said grain feed inlet end to said cooked grain outlet by continuously delivering said grain into said grain feed inlet end.

25. The method of claim 18 further comprising the step of conducting said grain delivered from said cooked grain outlet end of said cooking vessel through a flaker.

26. The method of claim 18 wherein said grain is delivered through said cooking vessel in a non-slurry form such that said grain is not suspended in a liquid medium.

27. The method of claim 26 further comprising the step of applying a sufficient amount of water to said grain in said cooking vessel such that a moisture content of said grain is increased.
